(19) United States
(12) Patent Application Publication
(10) Pub. No.: US 2014/0002768 A1
(43) Pub. Date: Jan. 2, 2014

(54) LCD DEVICE

(71) Applicants: Yicheng Kuo, Shenzhen (CN); Shihhsiang Chen, Shenzhen (CN); Gang Yu, Shenzhen (CN); Jiaqiang Wang, Shenzhen (CN)

(72) Inventors: Yicheng Kuo, Shenzhen (CN); Shihhsiang Chen, Shenzhen (CN); Gang Yu, Shenzhen (CN); Jiaqiang Wang, Shenzhen (CN)

(21) Appl. No.: 13/642,852

(22) PCT Filed: Jul. 9, 2012
(86) PCT No.: PCT/CN2012/078352

§ 371 Date: Oct. 22, 2012

(30) Foreign Application Priority Data
Jul. 2, 2012 (CN) 201210132044.0

(51) Int. Cl. G02F 1/13357

(52) U.S. Cl. 349/60; 349/58

(57) ABSTRACT

The present disclosure provides a liquid crystal display (LCD) device. The LCD device includes a front frame, a backplane fixed to the front frame, an optical assembly sandwiched between the front frame and the backplane, and an LCD panel arranged on a light emitting surface of the optical assembly. A side light incident surface of the optical assembly is correspondingly configured with a light source, and a shading member which is used for preventing light from directly entering inside of the LCD panel from the light source is arranged between the light source and the LCD panel. In the present disclosure, because the shading member used for preventing light from directly entering the inside of the LCD panel from the light source is arranged between the light source and the LCD panel, the light emitted by the light source cannot enter the inside of the LCD panel, thereby effectively avoiding hotspot phenomenon. Particularly, in the LCD device without a middle frame or with a sectioned middle frame, an edge of the LCD panel may be partially and directly exposed to the irradiated area of the light source. Thus, light can be effectively prevented from entering the inside of the LCD panel from the edge side by using the shading member of the present disclosure.

### TECHNICAL FIELD

The present disclosure relates to the field of liquid crystal displays (LCDs), and more particularly to an LCD device.

### BACKGROUND

A liquid crystal display (LCD) device generally includes a backplane, a middle frame, and a front frame. The backplane supports an optical assembly used for fixing a backlight module. The front frame surrounds an edge of an LCD panel; the middle frame is positioned between the front frame and the backplane, used for separating the optical assembly from the LCD panel, and matched with the front frame to fix the LCD panel. As shown in FIG. 1, in a typical LCD device without a middle frame, a backplane 300 is matched with a front frame 200 to fix the optical assembly to the LCD panel. When the design without a middle frame is used, because the side surface of an optical assembly 600 is configured with a light source assembly 400 (such as LED), strong light exists above the light source assembly, and may enter the LCD panel from the side of the LCD panel 100. Thus, hotspot may be generated on the LCD panel, and bright halo may form at the edge of the effective display area, resulting in the reduction of the display effect.

### SUMMARY

In view of the above-described problems, the aim of the present disclosure is to provide a liquid crystal display (LCD) device capable of preventing an LCD panel from generating hotspot.

The aim of the present disclosure is achieved by the following technical scheme.

An LCD device comprises a front frame, a backplane fixed to the front frame, an optical assembly sandwiched between the front frame and the backplane, and an LCD panel arranged on a light emitting surface of the optical assembly. A side light incident surface of the optical assembly is correspondingly configured with a light source, and a shading member which is used for preventing light from directly entering inside of the LCD panel from the light source is arranged between the light source and the LCD panel.

In one example, an edge of the LCD panel extends outside the range of the light emitting surface of the optical assembly, and forms an extension structure on one side corresponding to the light source. The shading member is fixed to the extension structure of the panel. This is a shading structure on the side of the panel. Part of light emitted by the light source directly enters the inside of the LCD panel from the extension structure, and the other part of light is reflected by the front frame and the backplane to emit to the extension structure from other directions. The shading member is directly fixed to the extension structure, to cover the position where light is easy to leak of the extension structure. Thus, no matter which direction light comes from, the light cannot be emitted into the extension structure. Compared with the shading structure on the side of the light source, the shading structure has better shading effect; the LCD panel is prevented from generating hotspot, and the display quality is increased.

In one example, the shading member is a shading tape. The shading tape has the advantages of convenient use and good generality, and is applicable to panels of different shapes and dimensions.

In one example, the shading tape is stuck on the side surface of the extension structure. Most light is leaked from the side facing the optical assembly.

In one example, the shading tape is stuck on the side surface of the extension structure and the side facing the optical assembly. Both the side surface and the side facing the optical assembly are stuck with the shading tape, thereby obtaining better effect of prevention of light leakage.

In one example, the shading tape is stuck around the surface of the extension structure. The whole extension structure is covered; thus, light emitted by the light source cannot enter the inside of the LCD panel from any angle, and the phenomenon of light leakage is further reduced.

In one example, the shading member is a shading slot configured with a groove; the extension structure of the LCD panel is inserted into the groove. The omnidirectional protection of light leakage can be achieved if the extension structure is inserted into the groove in a simple installation mode.

In one example, the shading member is a shading baffle with the length coincident with that of the light source. One side of the shading baffle is arranged at the edge of the light emitting surface of the optical assembly, and the other side is arranged at the top of the light source close to one end of the LCD panel. This is a shading member on the side of the light source. On the one hand, light is prevented from entering the LCD panel from the side surface of the LCD panel. On the other hand, the diffusing space of the light source is reduced, to make more light enter the optical assembly, thereby increasing the light utilization rate.

In one example, a light leakage space is formed between the top of the light source close to one end of the LCD panel and the front frame. The shading member is a rubber assembly filled in the light leakage space. The rubber assembly is configured with a support part extended to the light emitting surface of the optical assembly. This is another shading member on the side of the light source. Because the shading member is filled in the whole light leakage space, better light leakage prevention effect is obtained.

In the present disclosure, because the shading member used for preventing light from directly entering the inside of the LCD panel from the light source is arranged between the light source and the LCD panel, the light emitted by the light source cannot enter the inside of the LCD panel, thereby effectively avoiding hotspot phenomenon. Particularly, in the LCD device without a middle frame or with a sectioned middle frame, the edge of the LCD panel may be partially and directly exposed to the irradiated area of the light source. Thus, light can be effectively prevented from entering the inside of the LCD panel from the edge side by using the shading member of the present disclosure.

### BRIEF DESCRIPTION OF FIGURES

FIG. 1 is a typical LCD device without a middle frame;

FIG. 2 is a structure diagram of a first example of the present disclosure;

FIG. 3 is a structure diagram of a second example of the present disclosure;

FIG. 4 is a structure diagram of a shading member of a second example of the present disclosure;

FIG. 5 is a structure diagram of a shading member of a third example of the present disclosure; and

FIG. 6 is a structure diagram of another shading member of a third example of the present disclosure.

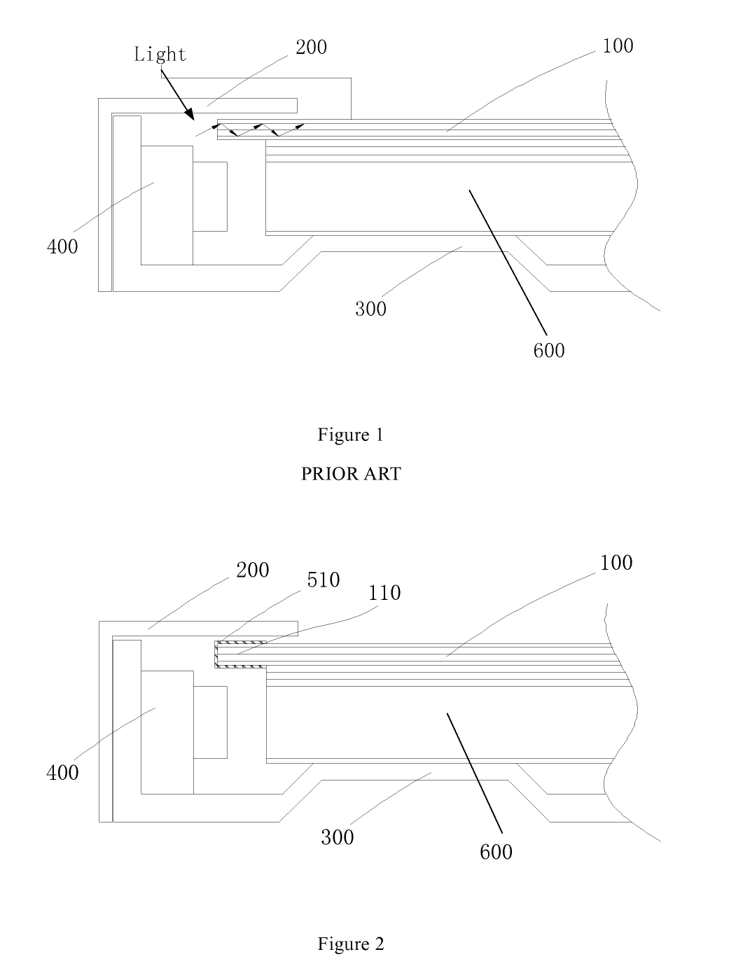

### LEGENDS

100. LCD panel;
110. extension structure;
200. front frame;
300. backplane;
400. light source;
510. shading tape;
520. shading slot;
521. groove;
530. shading baffle;
540. rubber assembly;
541. support part;
600. optical assembly.

### DETAILED DESCRIPTION

As shown in FIGS. 2-6, the present disclosure provides a liquid crystal display (LCD) device, comprising a front frame 200, a backplane 300 fixed to the front frame 200, an optical assembly 600 sandwiched between the front frame 200 and the backplane 300, and an LCD panel 100 arranged on a light emitting surface of the optical assembly 600. A side light incident surface of the optical assembly 600 is correspondingly configured with a light source 400, and a shading member which is used for preventing light from directly entering the inside of the LCD panel 100 from the light source 400 is arranged between the light source 400 and the LCD panel 100. The light emitting device, such as LED, cold cathode fluorescent lamp (CCFL), and the like, can be used as the light source.

In the present disclosure, because the shading member used for preventing light from directly entering the inside of the LCD panel 100 from the light source 400 is arranged between the light source 400 and the LCD panel 100, the light emitted by the light source 400 cannot enter the inside of the LCD panel 100, thereby effectively avoiding hotspot phenomenon. The present disclosure will further be described in detail in accordance with the figures and the preferable examples.

### Example 1

The example is the best example of the present disclosure. As shown in FIG. 2, an edge of the LCD panel 100 extends outside the range of the light emitting surface of the optical assembly 600, and forms an extension structure 110 on one side corresponding to the light source 400. The shading member is a shading tape 510, and the shading tape 510 is fixed to the extension structure 110 of the panel.

The shading tape 510 is stuck around the surface of the overall extension structure 110. Thus, the light emitted by the light source 400 cannot enter the inside of the LCD panel 100 from any angle, thereby obtaining better effect. Optionally, the shading tape 510 can be stuck on the side of the extension structure 110 facing the optical assembly 600 or can be stuck on the side surface of the extension structure 110 and the side facing the optical assembly 600.

In the example, the shading tape 510 is used as the shading member. The shading tape 510 has the advantages of convenient use, high generality, and low cost, and is applicable to panels of different shapes and dimensions.

### Example 2

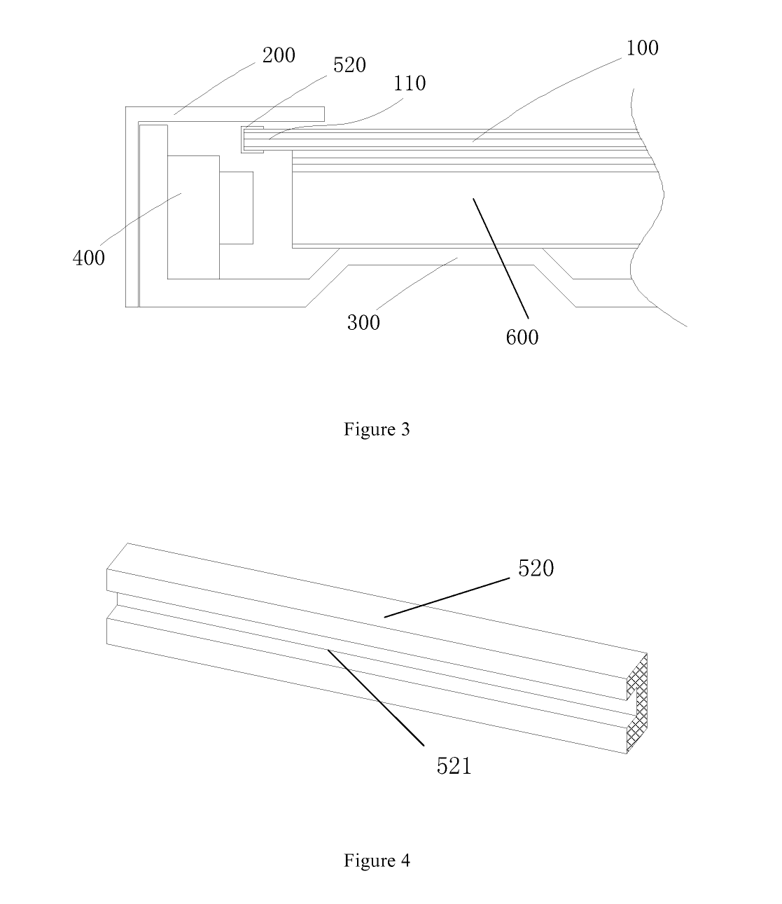

As shown in FIG. 3 and FIG. 4, the edge of the LCD panel 100 extends outside the range of the light emitting surface of the optical assembly 600, and forms an extension structure 110 on one side corresponding to the light source 400. The shading member is a shading slot 520 with a groove 521. The extension structure 110 of the LCD panel 100 is inserted into the groove 521 in a simple installation mode, to achieve omnidirectional protection from light leakage. The independent shading slot 520 is used for shading in the example.

### Example 3

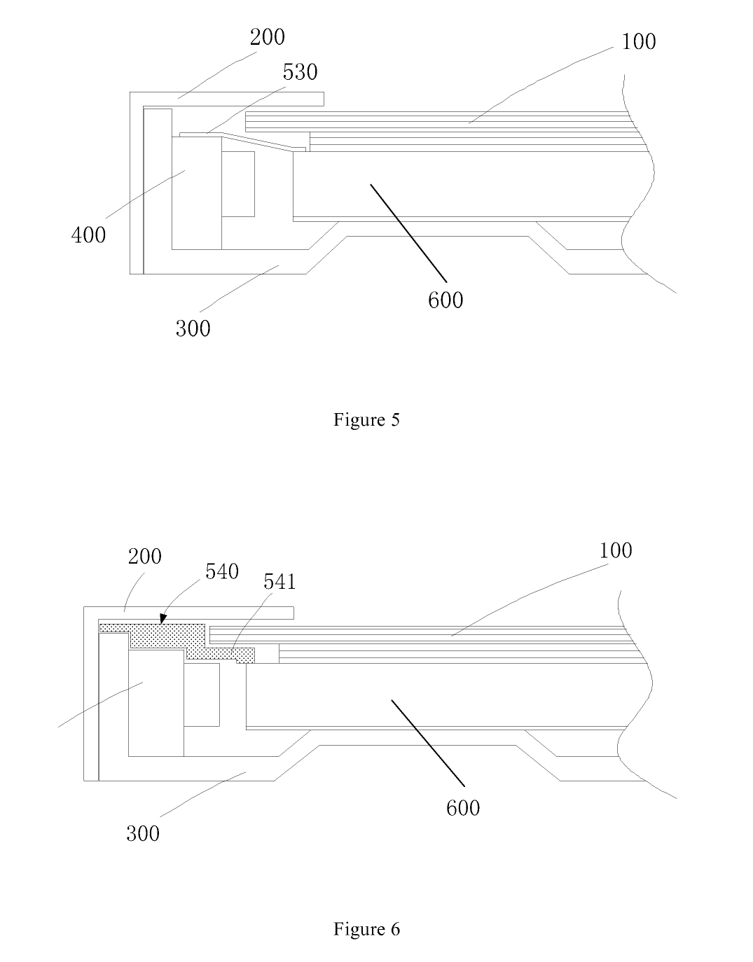

As shown in FIG. 5, the shading member is a shading baffle 530 with the length coincident with that of the light source 400. one side of the shading baffle 530 is arranged at the edge of the light emitting surface of the optical assembly 600, and the other side is arranged at the top of the light source 400 close to one end of the LCD panel 100. This is a shading member on the side of the light source 400. On the one hand, light is prevented from entering the LCD panel 100 from the side surface of the LCD panel 100. On the other hand, the diffusing space of the light source 400 is reduced, to make more light enter the optical assembly 600, thereby increasing the light utilization rate. Optionally, the structure shown in FIG. 6 can also be used, namely a light leakage space is formed between the top of the light source 400 close to one end of the LCD panel 100 and the front frame 200. The shading member is a rubber assembly 540 filled in the light leakage space. A support part 541 is extended from the rubber assembly 540 to the light emitting surface of the optical assembly 600. On the one hand, the support part 541 can be used for supporting the LCD panel 100, to play a role similar to a rubber frame. On the other hand, the support part 541 can completely shade light from the side of the light source, to prevent light from directly entering the LCD panel. Because the shading member is filled in the whole light leakage space, compared with the shading baffle, the shading member has the advantage of better effect of prevention of light leakage.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A liquid crystal display (LCD) device, comprising:
a front frame,
a backplane fixed to the front frame,
an optical assembly sandwiched between the front frame and the backplane, and
a liquid crystal display (LCD) panel arranged on a light emitting surface of the optical assembly;
wherein a side light incident surface of the optical assembly is correspondingly configured with a light source;
wherein an edge of the liquid crystal display (LCD) panel extends outside a range of the light emitting surface of the optical assembly, and forms an extension structure on one side corresponding to the light source; and
wherein a shading member which is used for preventing light from directly entering the inside of the liquid crystal display (LCD) panel from the light source is arranged between the light source and the liquid crystal display (LCD) panel, and the shading member is fixed to the extension structure.

2. A liquid crystal display (LCD) device, comprising:
a front frame,
a backplane fixed to the front frame,
an optical assembly sandwiched between the front frame and the backplane, and
a liquid crystal display (LCD) panel arranged on a light emitting surface of the optical assembly;
wherein a side light incident surface of the optical assembly is correspondingly configured with a light source, and a shading member which is used for preventing light from directly entering inside of the liquid crystal display (LCD) panel from the light source is arranged between the light source and the liquid crystal display (LCD) panel.

3. The LCD device of claim 2, wherein an edge of the LCD panel extends outside the range of the light emitting surface of the optical assembly, and forms an extension structure on one side corresponding to the light source; and the shading member is fixed to the extension structure of the panel.

4. The LCD device of claim 3, wherein the shading member is a shading tape.

5. The LCD device of claim 4, wherein the shading tape is stuck on a side surface of the extension structure.

6. The LCD device of claim 4, wherein the shading tape is stuck on a side surface of the extension structure and a side facing the optical assembly.

7. The LCD device of claim 4, wherein the shading tape is stuck around a surface of the extension structure.

8. The LCD device of claim 3, wherein the shading member is a shading slot configured with a groove; and the extension structure of the LCD panel is inserted into the groove.

9. The LCD device of claim 2, wherein the shading member is a shading baffle with a length coincident with that of the light source; one side of the shading baffle is arranged at an edge of the light emitting surface of the optical assembly, and the other side is arranged at the top of the light source close to one end of the LCD panel.

10. The LCD device of claim 2, wherein a light leakage space is formed between a top of the light source close to one end of the LCD panel and the front frame; the shading member is a rubber assembly filled in the light leakage space; the rubber assembly is configured with a support part extended to the light emitting surface of the optical assembly.
